(19) United States
(12) Patent Application Publication
(10) Pub. No.: US 2007/0026874 A1
(43) Pub. Date: Feb. 1, 2007

(54) [LIFE SAVING SYSTEM]

(75) Inventor: Jia-Chiou Liang, TAIPEI (TW)

Correspondence Address: JIA-CHIOU LIANG, P.O. BOX 108-00403, TAIPEI, TW

(73) Assignee: Jia-Chiou Liang, Taipei (TW)

(21) Appl. No.: 11/161,358

(22) Filed: Aug. 1, 2005

(51) Int. Cl. H04Q 7/20

(52) U.S. Cl. 455/456.5

(57) ABSTRACT

Disclosed is a life saving system, which includes an end-user unit carried on the lifejacket of the user in an aircraft or ship for providing a radio coordinates data of the end-user unit upon an accident subject to the operation of a global position signal receiver module and a starter, which starts the end-user unit when dipped in water or driven by the user, and a main unit carried by a lifeguard for searching the location of the end-user unit through the operation of a transmitter receiver module and a display.

### BACKGROUND OF THE INVENTION

1. Field of the Invention

The present invention relates to life saving apparatus and more particularly, to a life saving system, which enables the lifeguard to find the location of the user quickly upon an (aviation or marine) accident.

2. Description of the Related Art

When going to a far place, more particularly when going abroad, people usually takes an airplane or ship as the transportation vehicle. When an airplane or ship encountered an accident, the airplane or ship will provide an SOS signal by radio to call for help. However, the location of the signal source may not be the location where the accident occurred. When victims of the aviation or marine accident are floating on the sea, the waves or tidal currents of the sea may carry the victims to different locations in the sea, making the rescue difficult. Therefore, different life-saving appliances are developed. These commercial life-saving appliances help the users struggle for their life. A life-saving appliance (such as lifejacket) for this purpose is generally equipped with two blow tubes, an auto-charging cylinder, an alarm lamp, and a water chemical type battery. This type of life-saving appliance still cannot save the user's life for long during an aviation or marine accident, and the victim must have a certain time to wait for the help of rescuers. Conventional methods of rescuing people suffering from an aviation or marine accident have numerous drawbacks as follows.

1. Not easy to find the location of the victim: When a rescuer receives a signal from a victim of an aviation or marine accident, the rescuer may take a lot of time to reach the location where the signal was produced. When reached to the location where the signal was produced, the rescuer may be unable to find the victim who may be carried by a tidal current or sea waves to a distance far away from the location where the signal was produced. It is difficult to find a victim floating in the seat.

2. Wasting much time before giving a help to the victim: When an airplane exploded or a ship fell apart upon an accident, the rescuers cannot know the distribution of the victims, i.e., the rescuers cannot make up the shortest routing path for rescue, and much time and labor may be wasted in vain, resulting in an unexpected high mortality.

3. Not easy to find the alarm signal from the victim: When the rescuer is within a certain distance from the location of the victim, the rescuer can quickly find the victim subject to the visual signal of the alarm lamp of the victim's life-saving appliance. However, in case of a bad weather (raining or fogging), the rescuer may be unable to find the victim even the victim is not at a far location. Further, the battery of a life-saving appliance cannot support the functioning of the alarm lamp or buzzer for long. When over 72 hours, the chance of finding the victim becomes very low, and the victim may have no will to live after this golden 72 hours.

### SUMMARY OF THE INVENTION

The present invention has been accomplished under the circumstances in view. It is one object of the present invention to provide a life saving system, which enables the lifeguard to find out the location of the victim easily and quickly. It is another object of the present invention to provide a life saving system, which helps shortening the rescue time upon an accident. It is still another object of the present invention to provide a life saving system, which consumes less power supply. According to one aspect of the present invention, the life saving system comprises an end-user unit installed in a life saving appliance to be used by an end-user, and a main unit to be used by a lifeguard for searching the location of the end-user. The end-user unit provides a radio coordinate data signal to the main unit during an accident. The main unit displays the coordinates data of the end-user unit through a display when received the radio signal from the end-user unit, so that the lifeguard can quickly find the location of the end-user. Further, the main unit can be used with several end-user units. When an accident occurred, the lifeguard can make up the shortest routing path for rescue subject to the coordinates data of the respective end-user units displayed on the display of the main unit, thereby shorting the rescue time. Furthermore, the end-user unit is at the standby mode to save power consumption before receipt of an actuation signal from the main unit.

### BRIEF DESCRIPTION OF THE DRAWINGS

FIG. 1 is a system block diagram of a life saving system according to the present invention.

FIG. 2 is a system block diagram of an alternate form of the life saving system according to the present invention.

### DETAILED DESCRIPTION OF THE PREFERRED EMBODIMENT

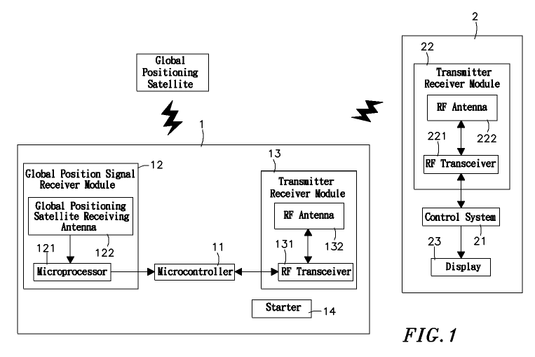

Referring to FIG. 1, a life saving system in accordance with the present invention is shown comprised of an end-user unit 1 and a main unit 2. The end-user unit 1 is to be carried by the user or mounted in a life saving appliance. The main unit 2 is to be used by a lifeguard.

The end-user unit 1 comprises a microcontroller 11, a global position signal receiver module 12, a transmitter receiver module 13, and a starter 14. The global position signal receiver module 12 and the transmitter receiver module 13 are respectively electrically connected to the microcontroller 11. The microcontroller 11 controls the operation of the global position signal receiver module 12. The global position signal receiver module 12 comprises a global positioning satellite receiving antenna 122 adapted to receive signal from a global positioning satellite, and a microprocessor 121 adapted to calculate the coordinates of the current location of the global position signal receiver module 12 subject to the signal received from a global positioning satellite by the global positioning satellite receiving antenna 122. The transmitter receiver module 13 comprises a RF (Radio Frequency) transceiver 131 adapted to modulate output signal from the microcontroller 11 into radio signal for transmitting to the main unit 2 and to demodulate radio signal received from the main unit 2 and to send demodulated signal to the microcontroller 11, and a RF antenna 132 adapted to transmit modulated radio signal from the RF transceiver 131 to the main unit 2 by radio and to receive radio signal from the main unit 2 and to transmit received radio signal to the RF transceiver 131 for demodulation. The starter 14 uses a battery or switch to start the operation of the end-user unit 1 and to provide the end-user unit 1 with the necessary working voltage. The battery used can be a submerged type or waterproof battery that starts to provide electricity to the end-user unit 1 when touched water.

The main unit 2 comprises a control system 21, a transmitter receiver module 22, and a display 23. The transmitter receiver module 22 and the display 23 are respectively electrically connected to the control system 21. The control system 21 controls the operation of the transmitter receiver module 22. The transmitter receiver module 22 comprises a RF transceiver 221 adapted to modulate output signal from the control system 21 into radio signal for transmitting to the end-user unit 1 and to demodulate radio signal received from the end-user unit 1 and to send demodulated signal to the control system 21, and a RF antenna 222 adapted to transmit modulated radio signal from the RF transceiver 221 to the end-user unit 1 by radio and to receive radio signal from the end-user unit 1 and to transmit received radio signal to the RF transceiver 21 for demodulation.

When the end-user encounters an emergency (aviation or marine accident) and is struggling for his (her) life, the starter 14 automatically starts the end-user unit 1 (if the battery is dipped in water), or the user can drive the starter 14 to start the end-user unit 1. At this time, the end-user unit 1 begins to scan signal. When the lifeguard carries the main unit 2 to search the victim, the control system 21 keeps sending an actuation signal through the transmitter receiver module 22 to the end-user unit 1 at a predetermined time interval. Upon receipt of the actuation signal from the main unit 2, the transmitter receiver module 13 of the end-user unit 1 immediately demodulates the signal and sends the demodulated signal to the microcontroller 11, causing the microcontroller 1 to start the global position signal receiver module 12. When started the global position signal receiver module 12, the global positioning satellite receiving antenna 122 starts to receive signal from the global positioning satellite, and sends the received satellite signal to the microprocessor 121 for calculating the coordinates of the end-user unit 1. After calculation, the microprocessor 121 immediately sends the coordinates data to the microcontroller 11, enabling the microcontroller 11 to drive the transmitter receiver module 13 to send the coordinates data of the end-user unit 1 to the transmitter receiver module 22 of the main unit 2 by radio. Upon receipt of the radio signal containing the coordinates data of the end-user unit 1, the transmitter receiver module 22 demodulates the signal and sends the demodulated signal to the control system 21, which drives the display 23 to display the coordinates data of the end-user unit 1. Thus, the lifeguard can quickly find the location of the victim and takes the necessary measure to save the victim's life.

Further, the control system 21 has an electronic map stored therein for quick allocation of the coordinates data received from the end-user unit 1. The aforesaid life saving appliance can be a lifejacket or floatable seat pad.

Further, the transmission band used by the transmitter receiver modules 13 and 22 of the end-user unit 1 and main unit 2 can be the Emergency Band, ISM Band (Industrial Scientific and Medical Band), or semiduplex two-way communication system. The main unit 2 can be a computer, PDA (Personal Digital Assistant), or cellular telephone.

Further, when an emergency is occurred, the starter 14 initiates or is driven to initiate the (battery) power supply for the end-user unit 1. After initiation of the (battery) power supply, the end-user unit 1 enters the standby mode, and will start to send the coordinate signal to the main unit 2 only after receipt of the actuation signal from the main unit 2, saving the consumption of the (battery) power supply.

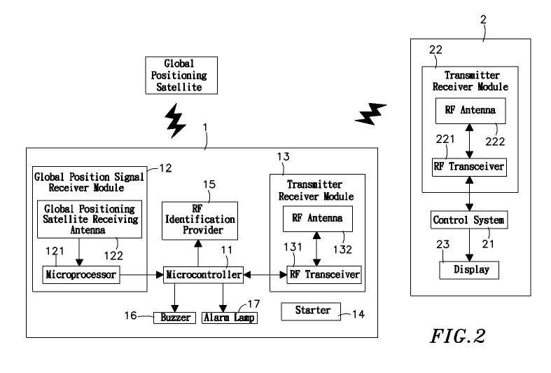

FIG. 2 is a system block diagram of an alternate form of the present invention. This embodiment is substantially similar to the embodiment shown in FIG. 1 with the exception of the added RF identification provider 15, buzzer 16 and alarm lamp 17. As illustrated, the RF identification provider 15, the buzzer 16 and the alarm lamp 17 are respectively electrically connected to the microcontroller 11. When sending the coordinate signal to the main unit 2, the end-user unit 1 simultaneous provides the identification data of the end-user unit 1 (for example, the seat number of the end-user unit 1 in the aircraft) to the main unit 2. Further, the microcontroller 11 drives the buzzer 16 to produce an audio alarm signal and the alarm lamp 17 to produce a visual alarm signal after receipt of the actuation signal from the main unit 2.

Further, if the end-user unit 1 sinks with the end-user in the sea, the microcontroller 11 will automatically cuts off the (battery) power supply from the end-user unit 1 and drives the buzzer 16 to buzz, producing a sound wave for enabling the lifeguard to search the location of the victim by a sonar.

As indicated above, the invention provides a life saving system, which has the following advantages.

1. Easy to find the location of the victim: When an aviation or marine accident occurred, the end-user unit immediately provides a radio coordinate data signal to the main unit when received a radio actuation signal from the main unit. Upon receipt of the radio coordinate data signal from the end-user unit, the main unit displays the coordinates data of the end-user unit on the display thereof, and therefore the rescuer can quickly find the victim.

2. Shortening the rescue time upon an accident: The main unit can be used with several end-user units. When an accident occurred, the rescuer can make up the shortest routing path for rescue subject to the coordinates data of the respective end-user units displayed on the display, thereby shorting the rescue time.

3. Low battery power consumption: The end-user unit is at the standby mode before receipt of the actuation signal from the main unit, and the end-user unit starts to send the radio coordinates data signal to the main unit only when the rescuer is within a certain distance from the victim. Therefore, the battery power supply can be efficiently used for driving the alarm lamp and the buzzer to call the rescuer's attention.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A life saving system comprising an end-user unit installed in a life saving appliance to be used by an end-user, and a main unit to be used by a lifeguard to search the location of said end-user, wherein:
said end-user unit comprises a global position signal receiver module adapted to receive signal from a predetermined global positioning satellite and to calculate coordinates data of the current location of said end-user, a transmitter receiver module adapted to send said calculated coordinates data to said main unit by radio and to receive radio signal from said main unit, a microcontroller adapted to connect to said global position signal receiver module and said transmitter receiver module electrically, and starter means adapted to start said end-user unit upon an emergency;
said main unit comprises a transmitter receiver module adapted to receive said coordinates data signal from said end-user unit for enabling said lifeguard to search the location of the end-user using said end-user unit, display means adapted to display said coordinates data of said user-end unit, and a control system adapted to connect to said transmitter receiver module and said display.

2. The life saving system as claimed in claim 1, wherein said global position signal receiver module of said end-user unit comprises a global positioning satellite receiving antenna adapted to receive signal from said predetermined global positioning satellite, and a microprocessor adapted to calculate said coordinates of the current location of said global position signal receiver module subject to said signal received from said predetermined global positioning satellite by said global positioning satellite receiving antenna.

3. The life saving system as claimed in claim 1, wherein said transmitter receiver module of said end-user unit comprises a RF (Radio Frequency) antenna adapted to receive and transmit radio signal, and a RF (Radio Frequency) transceiver electrically connected to modulate/demodulate signal.

4. The life saving system as claimed in claim 1, wherein the transmitter receiver module of said main unit comprises a RF (Radio Frequency) antenna adapted to receive and transmit radio signal, and a RF (Radio Frequency) transceiver electrically connected to modulate/demodulate signal.

5. The life saving system as claimed in claim 1, wherein said control system of said main unit comprises a built-in electronic map for quick allocation of said coordinates data received from said end-user unit through said display means.

6. The life saving system as claimed in claim 1, wherein said microcontroller of said end-user unit has a RF (Radio Frequency) identification provider electrically connected thereto and adapted to provide identification data of said end-user unit to said main unit.

7. The life saving system as claimed in claim 1, wherein said end-user unit further comprises a buzzer electrically connected to said microcontroller and controllable by said microcontroller to produce an audio alarm signal.

8. The life saving system as claimed in claim 1, wherein said end-user unit further comprises an alarm lamp electrically connected to said microcontroller and controllable by said microcontroller to produce a visual alarm signal.

9. The life saving system as claimed in claim 1, wherein said starter means comprises an on/off switch.

10. The life saving system as claimed in claim 1, wherein said starter means is a submerged type battery that switches on said end-user unit when dipped in water.

11. The life saving system as claimed in claim 1, wherein said main unit is a computer.

12. The life saving system as claimed in claim 1, wherein said main unit is a PDA (Personal Digital Assistant).

13. The life saving system as claimed in claim 1, wherein said life saving appliance is a lifejacket.

14. The life saving system as claimed in claim 1, wherein said life saving appliance is a floating seat pad.

15. The life saving system as claimed in claim 1, wherein said transmitter receiver modules of said end-user unit and said main unit commonly use Emergency Band for transmitting signal.

16. The life saving system as claimed in claim 1, wherein said transmitter receiver modules of said end-user unit and said main unit commonly use ISM Band (Industrial Scientific and Medical Band) for transmitting signal.
